(19) United States
(12) Patent Application Publication
(10) Pub. No.: US 2007/0002429 A1
(43) Pub. Date: Jan. 4, 2007

(54) Optical channel monitor

(75) Inventors: Shin Kamei, Tokyo (JP); Yasuyuki Suzuki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/433,735

(22) Filed: May 15, 2006

(30) Foreign Application Priority Data
Jun. 17, 2005 (JP) 2005-177209

(51) Int. Cl. H01S 3/00; H04B 10/12

(52) U.S. Cl. 359/337.5

(57) ABSTRACT

There is achieved an optical channel monitor capable of preventing deviation of an image formation position due to variation in ambient temperature. The optical channel monitor comprising a wavelength-dispersion element for receiving light from a light source, containing a plurality of wavelengths, via a collimating lens, a focusing lens for condensing spectral light components converted from said light by the wavelength-dispersion element, and photodiode array elements for receiving the respective spectral light components condensed by the focusing lens, wherein deviation in positions shined by the respective spectral light components incident on a photodiode array, due to variation in respective physical quantities of optical components including the collimating lens, the wavelength-dispersion element, the photodiode array, and support members for supporting the optical components, attributable to variation in ambient temperature, is corrected through combination of the support members for supporting the optical components.

### FIELD OF THE INVENTION

The present invention relates to an optical channel monitor, and in particular, to an optical channel monitor for high-speed monitoring of optical signals of a wavelength division multiplexing (WDM) system among optical communication systems.

### BACKGROUND OF THE INVENTION

In Patent Document 1 described hereunder, there is disclosed a system wherein light is caused to undergo wavelength dispersion by shining incident light on a diffraction grating serving as a wavelength-dispersion element, and so forth, and said light is received by a photodiode array (hereinafter referred to as a PD array) to be thereby separated into spectral light components by the wavelength before detection.

(Patent Document 1)

JP 2004-138515-A

FIG. 4 is a block diagram showing an example of a spectroscope employing a PD array as a detection element. In FIG. 4, reference numeral 1 denotes an emission end for emitting an output light from a light source, or light from an optical fiber, 2 a collimating lens, 3 a wavelength-dispersion element such as a diffraction grating, and so forth, 4 a focusing lens, and 5 a PD array.

Light emitted from the emission end 1 is converted into collimated light rays by the collimating lens 2 before falling on the wavelength-dispersion element 3. Spectral light components from the wavelength-dispersion element 3, subjected to wavelength dispersion, are condensed by the focusing lens 4 before falling on the PD array 5.

As the spectral light components falling on the diffraction grating 3 have each a diffraction angle differing by the wavelength thereof, the spectral light components are each emitted in different directions, as diffracted light rays, to be then condensed by the focusing lens 4, respectively, before falling on the PD array 5.

In FIG. 4, the diffracted light rays differing from each other in wavelength are condensed on PD array elements of the PD array 5, positioned at “FP01”, “FP02”, and “FP03”, respectively. With the spectroscope described as above, there is no need for rotating the diffraction grating 3, so that the same is excellent in speed-up and reliability.

Assuming that the diffraction grating 3 has, for example, spectral orders “m”, grating constant “d”, the angle of incidence on the diffraction grating 3 “i”, the angle of emission “θ”, and wavelength “λ”, the following equation holds.
mλ/d=(sin i+sin θ) (1)

In the case of designing the spectroscope as shown in FIG. 4 so as to handle a narrow wave range as with the case of a monitor for monitoring a WDM transmission system, and so forth, spread of an optical path, due to wavelength dispersion, becomes smaller in comparison with a focal length of the focusing lens 4, so that the angles of emission are substantially in a proportional relationship with positions of the respective PD array elements when employing the PD array 5 with the PD array elements that are one-dimensionally arrayed.

However, respective relationships between the wavelengths and the angles of emission are represented by the following equation derived by differentiating the equation (1):
dλ/dθ|i=(d/m)·cos θ (2)

As is evident from the equation (2), the wavelength and the angle of light dispersion come to be proportional to cosine of the angle of emission. The angle of emission can be found from the equation (1) by use of the wave range of the spectroscope, the grating constant of the diffraction grating 3 in use, the focal length of the focusing lens 4, and so forth.

FIG. 5 is a block diagram of another conventional example, showing a state where a mirror 5 is disposed in a stage after a focusing lens 4, and reflected light from the mirror 6 falls on a PD array 5.

FIG. 6 is a schematic illustration showing a state where one of spectral light components as focused falls on the PD array 6, and the center of optical power “a” shines a PD array element indicated by 6a to thereby provide the maximum output b of the PD array.

### SUMMARY OF THE INVENTION

Now, glass components for use in such an optical system as described have refractive indexes undergoing variation according to temperature, and undergo expansion and contraction according to temperature. Accordingly, an optical path, and an image formation position have temperature dependency.

With the diffraction grating in particular, there is a problem in that spacing between adjacent grooves undergoes variation as temperature undergoes variation, so that spectral light components incident on the respective PD array elements undergo deviation, ending in failure to implement accurate monitoring. Particularly pronounced is the variation of the spacing between the adjacent grooves of the diffraction grating, due to variation in temperature, and the variation of the spacing causes the image formation positions, in the direction of a row of the PD array elements, to be deviated, due to the variation in temperature.

As a conventional means for eliminating the temperature dependency of the image formation positions on the respective PD array elements, due to variation in ambient temperature, there has been adopted an apparatus wherein temperature control means such as a Peltier element/thermistor, and so forth are provided to thereby control temperature in electrical circuitry, and the temperature dependency of the image formation positions, in the direction of the row of the PD array elements, on the PD array, is cancelled by use of a temperature correction factor, thereby computing an output of a true wavelength.

However, with the optical channel monitor, there have lately been arisen mounting requirements for miniaturization, further reduction in cost, and further power saving, but a problem has existed that in view of the requirements as described, it is difficult to provide the optical channel monitor with a temperature control mechanism in the conventional manner. Further, the optical channel monitor described is designed to receive light with a number of the PD array elements, corresponding to the number of channels as multiplexed (one channel corresponding to one element). Accordingly, in order to implement a configuration for obtaining accurate power for each of the channels, there is sought after an optical design insusceptible to occurrence of variation in the image formation positions, dependent on temperature, so as to prevent light from leaking from the respective PD array elements.

The present invention has been developed in order to solve the problems described as above, and it is an object of the present invention to provide an optical channel monitor wherein support members for supporting optical components are disposed so as to be combined with each other in such a way as to prevent deviation of image formation positions by taking advantage of difference in coefficient of thermal expansion of the support members, and to achieve miniaturization as well as reduction in thickness of the optical channel monitor.

To that end, in accordance with a first aspect of the invention, there is provided an optical channel monitor comprising a wavelength-dispersion element for receiving light from a light source, containing a plurality of wavelengths, via a collimating lens, a focusing lens for condensing spectral light components converted from said light by the wavelength-dispersion element, and photodiode array elements for receiving the respective spectral light components condensed by the focusing lens, wherein deviation in positions shined by the respective spectral light components incident on a photodiode array, due to variation in respective physical quantities of optical components including the collimating lens, the wavelength-dispersion element, the photodiode array, and support members for supporting the optical components, attributable to variation in ambient temperature, is corrected through combination of the support members for supporting the optical components.

With the optical channel monitor having those features, for members making up the respective support members, members differing in coefficient of linear expansion from each other are preferably combined with each other for use.

In combining the support members together, use is preferably made of three kinds of members differing in coefficient of linear expansion from each other.

As is evident from the description in the foregoing, the present invention has the following advantageous effects. As respective positions of the optical components are caused to make a shift according to deviation in image formation positions, attributable to variation in temperature, it is possible to prevent the deviation in image formation positions on the respective PD array elements while implementing miniaturization as well as reduction in thickness of the optical channel monitor.

### BRIEF DESCRIPTION OF THE DRAWINGS

FIG. 1 is a block diagram showing the principal parts of one embodiment of an optical channel monitor according to the invention;

FIG. 2 is a schematic illustration showing respective outputs of spectral light components at different wavelengths, incident on respective PD array elements, by way of example;

FIG. 3 is a schematic representation showing an example of a configuration for holders for supporting optical components, and a lens holder;

FIG. 4 is a block diagram showing an example of an optical channel monitor to which the invention is applied;

FIG. 5 is a block diagram of another conventional example of an optical channel monitor; and

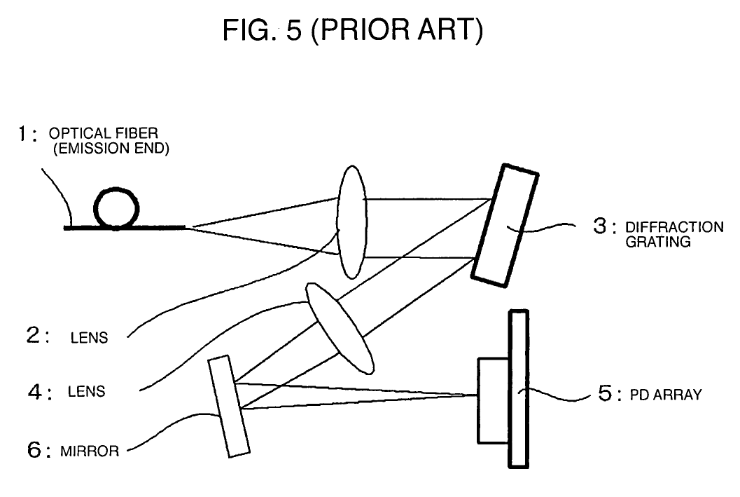

FIG. 6 is a schematic illustration showing a relationship between respective wavelengths of spectral light components incident on a PD array, and outputs of respective PD array elements.

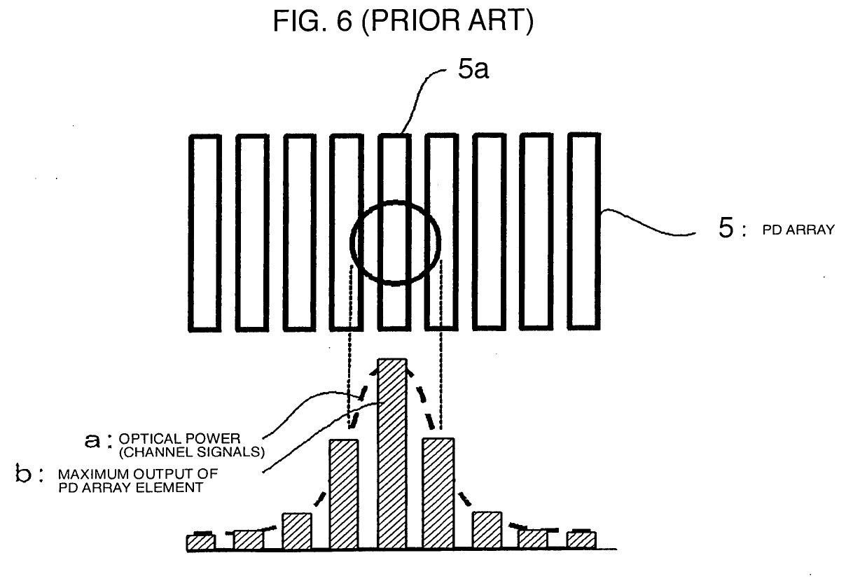

### PREFERRED EMBODIMENT OF THE INVENTION

An embodiment of the invention is described in detail hereinafter with reference to the accompanying drawings.

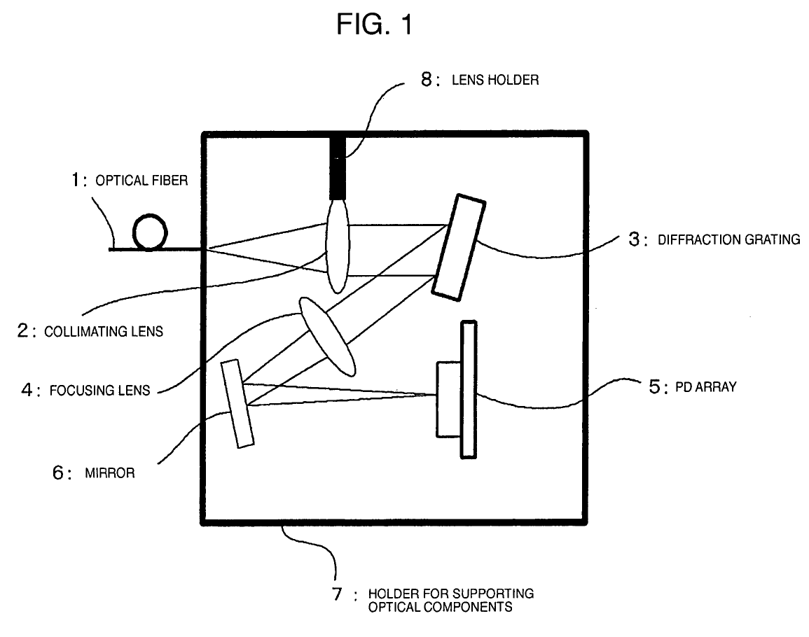

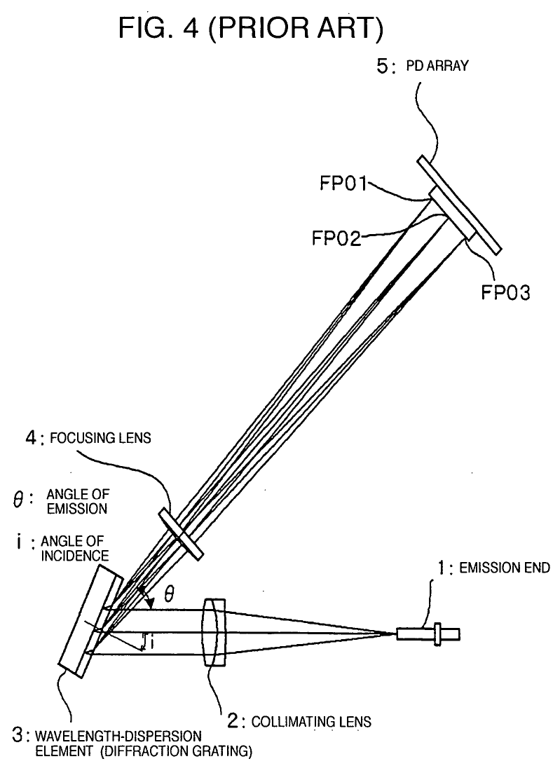

FIG. 1 is a block diagram showing the principal parts of one embodiment of an optical channel monitor according to the invention. In the figure, constituent elements identical to those in the conventional example described with reference to FIG. 4 are denoted by like reference numerals, thereby omitting description thereof. In FIG. 1, reference numeral 7 denotes a holder (installation block) for supporting optical components, in a box shape, made of a metal (for example, Kovar) low in coefficient of thermal expansion. Kovar has the property of its coefficient of thermal expansion being low {11.5(10−6/K)}. Reference numeral 8 denotes a lens holder fixedly attached to one side of the installation block 7, and a collimating lens 2 is shown to be supported by the tip of the lens holder 8. For the lens holder 8, use is made of, for example, aluminum, which is a metal high in coefficient of thermal expansion, in combination with Invor and so forth.

More specifically, a constituent material different from a constituent material used in the holder (installation block) 7 for supporting the optical components is used for the lens holder (arm) 8 supporting the collimating lens 2, within an optical system inside the holder (installation block) 7 for supporting the optical components making up a channel monitor, so that the channel monitor is designed to cause the collimating lens 2 to make a relative shift by taking advantage of difference in coefficient of linear expansion between both the constituent materials to thereby reduce temperature coefficient, enabling variation in optical image formation positions to be physically cancelled.

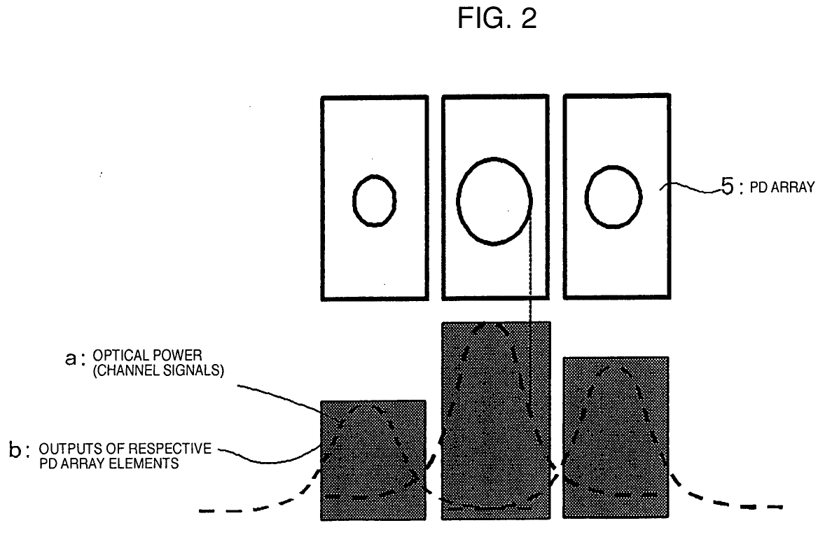

FIG. 2 shows optical power (channel signals) of spectral light components, and outputs of respective PD array elements by way of example, showing a state where maximum values of the respective channel signals are inputted to the centers of the respective PD array elements, and there are produced the respective outputs corresponding to the relevant optical power.

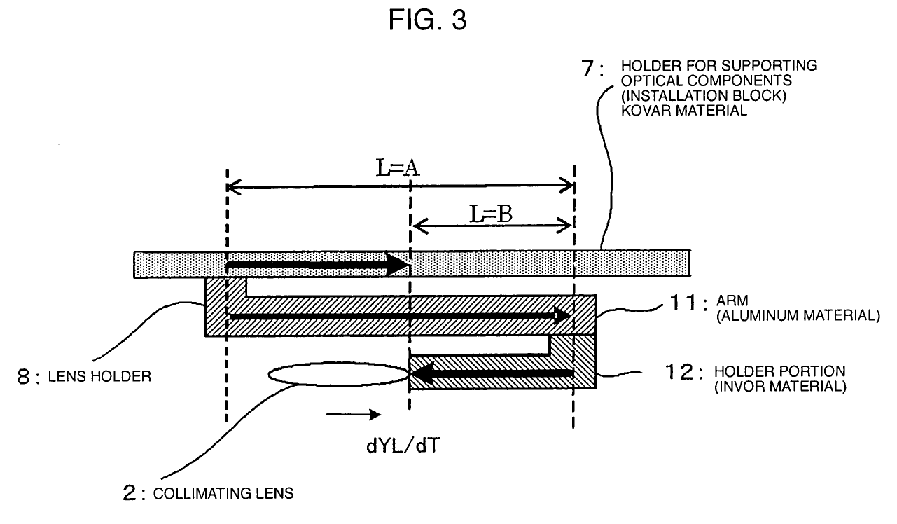

FIG. 3 is a schematic representation showing an example of a configuration for the holder 7 as an example of a member for supporting the optical components, and the lens holder 8.

In FIG. 3, a Kovar material is used for a part corresponding to “the holder (installation block) 7 for supporting the optical components” in FIG. 1, an aluminum material is used similarly for a part corresponding to an arm of “the lens holder (arm) 8”, and an Invor material is used for a holder portion 12 for directly supporting the collimating lens 2.

Now assuming that a shift quantity of the lens is YL per temperature change T, coefficient of linear expansion of the Kovar material used for “the holder (installation block) 7 for supporting the optical components is αₖᵥ, coefficient of linear expansion of the aluminum material used for the arm 11 as a constituent of the lens holder 8 is αₐₗ, and a length thereof is A, and further assuming that coefficient of linear expansion of the Invor material used for the holder portion 12 as a constituent of the lens holder 8 is αᵢᵥ, and a length thereof is B, the following relationship holds:
dYL/dt=αₐₗ·A·αᵢᵥ·B·αₖᵥ·(A B)
Hence, if the length A of the arm is found, and dYL/dt is obtained through an optical simulator, the length B can be found, so that it is possible to construct a mechanism capable of causing the lens to a make a slight movement according to temperature so as to cancel temperature dependency of the mechanism.

The respective coefficients of linear expansion of the constituent materials described as above are as follows:
Kovar: 5.0[×10⁻⁶/°C.]
Aluminum: 23.8[×10⁻⁶/°C.]
Invor: 0.9[×10⁻⁶/°C.]

In actual manufacture of the optical channel monitor, decision on A and B are to be made while repeating testing by taking into account qualities of respective constituent materials of the diffraction grating 3, the focusing lens 4, the mirror 6 and the PD array 5, as well as qualities, sizes, and shapes of respective members for supporting the former. Further, it is to be pointed that the description given hereinbefore shows only a specific preferred embodiment of the invention by way of example in order to explain the present invention for illustrative purposes only.

Hence it is our intention that the invention be not limited to the embodiment described as above and that various changes and modifications may be made in the invention without departing from the spirit and scope thereof.

What is claimed is:

1. An optical channel monitor comprising a wavelength-dispersion element for receiving light from a light source, containing a plurality of wavelengths, via a collimating lens, a focusing lens for condensing spectral light components converted from said light by the wavelength-dispersion element, and photodiode array elements for receiving the respective spectral light components condensed by the focusing lens, wherein deviation in positions shined by the respective spectral light components incident on a photodiode array, due to variation in respective physical quantities of optical components including the collimating lens, the wavelength-dispersion element, the photodiode array, and support members for supporting the optical components, attributable to variation in ambient temperature, is corrected through combination of the support members for supporting the optical components.

2. An optical channel monitor according to claim 1, wherein for members making up the respective support members, members differing in coefficient of linear expansion from each other are combined with each other for use.

3. An optical channel monitor according to claim 2, wherein use is made of three kinds of members differing in coefficient of linear expansion from each other.
